(19) United States
(12) Patent Application Publication
(10) Pub. No.: US 2008/0225656 A1
(43) Pub. Date: Sep. 18, 2008

(54) Cross-Talk Cancellation in Three-Spots Push-Pull Tracking Error Signal in Optical Disc Systems

(75) Inventors: Sjoerd Stallinga, Eindhoven (NL); Bin Yin, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/067,836

(22) PCT Filed: Sep. 13, 2006
(86) PCT No.: PCT/IB2006/053250

§ 371 Date: Mar. 24, 2008

(30) Foreign Application Priority Data
Sep. 22, 2005 (EP) 05108772.4

(51) Int. Cl. G11B 7/00

(52) U.S. Cl. 369/44.32

(57) ABSTRACT

A method and system for cross-talk cancellation in a three-spots push-pull tracking error signal in an optical disc system is disclosed. A tracking error signal (TES) is determined from a plurality of error signals (PPₐ, PP_{b}, PP_{C}). A noise signal (N) is determined from at least two of the plurality of error signals. The noise signal is filtered in a first filter (406). The filtered noise signal is subtracted from the tracking error signal (TES) to produce a resultant error signal (TES_{XTC}), wherein filter coefficients of the filter (406) are selected by minimizing cross-correlation between the noise signal (N) and the resultant error signal (TES_{XTC})

This invention pertains in general to the field of optical disc systems. More particularly the invention relates to cross-talk cancellation in three-spots push-pull signal tracking error in optical disc systems.

Different formats of optical recording medium including read-only optical discs, such as CD (Compact Disk), and DVD (Digital Versatile Disc); and recordable optical discs such as a CD-R (Compact Disc-Recordable), CD-RW (Compact Disc-Rewritable) and DVD+RW (Digital Versatile Disc+Rewritable); and Blu-ray discs (BD) are well known. These optical recording media may be written and/or read out by means of an optical pick up unit or a read head in an optical scanning device. The optical pick up unit is mounted on a linear bearing for radially scanning across the tracks of the optical disc. The read head may comprise, among other elements, an actuator for focusing, radial tracking and tilting the lens.

The optical scanning device comprises a light source such as a laser which emits light that is focused onto the information layer in the disc. In addition to detecting and reading the information from the optical disc, the optical pick up unit also detects a variety of error signals, e.g., focus error and radial tracking error. These error signals are used by the optical scanning device to adjust various aspects of the scanning procedure to help reduce these errors. For example, the focus error signal can be used to determine how much the focus actuator should be steered to improve the focus of the laser.

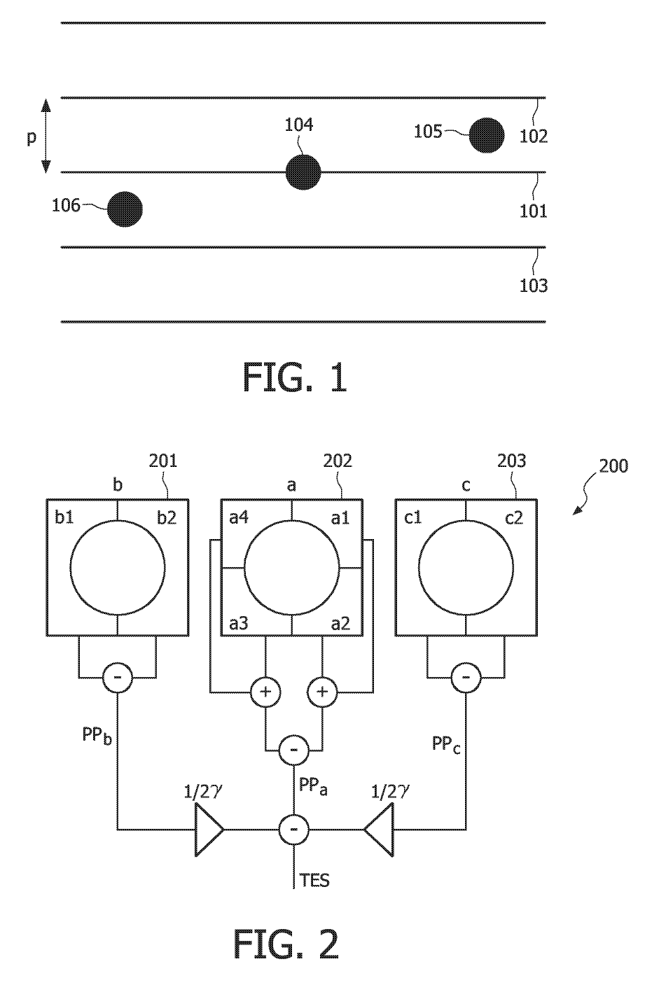

Optical disc drives that are capable of handling recordable and/or rewritable drives rely on the push-pull error signal for radial tracking, i.e. the method to keep the scanning spot on the spiral track in the information layer of the disc. As illustrated in FIG. 1, the information layer of a disc 100 comprises a main track 101, a first adjacent track 102 and a second adjacent track 103, wherein the tracks are spaced by a distance p, the track pitch. The information is read/written with the main scanning spot 104. For tracking purposes, there are also a first satellite spot 105 and a second satellite spot 106, which are halfway between the main track and the adjacent tracks. The push-pull signal is found by taking the difference signal of various detector segments. A known detector 200 for determining the push-pull tracking error signal is illustrated in FIG. 2. The detector 200 comprises a plurality of detectors 201, 202, 203 for detecting energy from each of the three scanning spots. In the nominal case it varies periodically with the radial position of the scanning spot with respect to the tracks:

Ppₐ=A sin φ (1)

where A is the amplitude, and φ=2πy/p with y the radial position and p the track pitch. Clearly, the push-pull signal is zero when the scanning spot is on the track. Due to a displacement of the spot with respect to the detector an offset can occur, which is called beamlanding. The push-pull signal is then:

PPₐ=A sin φ+B (2)

where B is the beamlanding contribution. In order to overcome the beamlanding-induced tracking offsets, the so-called three-spots push-pull (3SPP) error signal is used in most cases in practice. As illustrated in FIG. 2, this signal is a weighted sum of three push-pull signals (PPₐ, PP_{b}, PP_{c}), the three signals originating from the main scanning spot 104 (PPₐ) and from the two satellite spots 105, 106 (PPₐ, PP_{b}), respectively. The power of the satellite spots is commonly a factor γ= 1/15 smaller than the power of the main spot. While the main spot is on track, the two satellite spots are generally halfway the central track and the adjacent tracks. The satellite push-pull signals are thus:

PP_{b}=−γA sin φ+γB

PP_{c}=−γA sin φ+γB (3)

The tracking error signal (TES) is defined as:

$$\begin{matrix}TES = {PP}_{a} - ( {PP}_{b} + {PP}_{c} ) / 2 γ \\ = 2 A sin φ\end{matrix} \qquad ( 4 )$$

Clearly, all effects of beamlanding are cancelled.

However, a problem arises when additional noise sources are present that are not equal for all detector parts a, b, and c (up to the overall scaling with γ for the satellites), i.e. if:

PPₐ=A sin φ+B+Nₐ

PP_{b}=−γA sin φ+γB+γN_{b}

PP_{c}=−γA sin φ+γB+γN_{c} (5)

where Nₐ≠N_{b}≠N_{c}. This can occur, for example, in discs with more than one information layer. Light emanating from the out-of-focus information layer(s) can end up at the detector parts a, b, and c, (201, 202, 203) and give rise to interference there. The interference, or so-called inter-layer cross talk, results in an extra signal in push-pull channels in the case of, for example, radial tilt. Depending on the phase difference that determines the interfering result and that can be varying due to, for example, spacer thickness variation, this extra signal can be fluctuating and becomes a noise source to the push-pull signal. In practice, this noise differs on the detector parts a, b and c. This gives a tracking error signal TES with an offset Nₐ−(N_{b}+N_{c})/2:

TES=2A sin φ+Nₐ−(N_{b}+N_{c})/2 (6)

Thus, there is a need for a method and apparatus for eliminating the noise component of the radial error signal.

Accordingly, the present invention preferably seeks to mitigate, alleviate or eliminate one or more of the above-identified deficiencies in the art and disadvantages singly or in any combination and solves at least the above mentioned problems by providing a system, a method, and a computer-readable medium for eliminating the noise component of a multiple-spot push-pull radial error signal in an optical disc system according to the appended patent claims.

According to one aspect of the invention, a method for cross-talk cancellation in a multiple-spots push-pull tracking error signal in an optical storage medium system is disclosed. The method comprises determining a tracking error signal from a plurality of error signals; determining a noise signal from at least two of the plurality of error signals; filtering said noise signal in a first filter; subtracting said filtered noise signal from said tracking error signal to produce a resultant error signal, wherein filter coefficients of the first filter are selected by minimizing cross-correlation between the noise signal and the resultant error signal. The method may further comprise removing a noise component from said noise signal prior to determining filter coefficients of the filter.

According to one aspect of the invention, a system for cross-talk cancellation in a multiple-spots push-pull tracking error signal in an optical storage medium system is disclosed. The system comprises: means for determining a tracking error signal from a plurality of error signals; means for determining a noise signal from at least two of the plurality of error signals; a first filter for filtering said noise signal; means for subtracting said filtered noise signal from said tracking error signal to produce a resultant error signal, wherein filter coefficients of the first filter are selected by minimizing cross-correlation between the noise signal and the resultant error signal. The system may further comprise means for removing a noise component from said noise signal prior to determining filter coefficients of the filter.

According to a further aspect of the invention, a computer-readable medium having embodied thereon a computer program for cross-talk cancellation in a multiple-spots push-pull tracking error signal in an optical storage medium system, for processing by a computer is provided. The computer program comprises a code segment for determining a tracking error signal from a plurality of error signals; a code segment for determining a noise signal from at least two of the plurality of error signals; a code segment for filtering said noise signal in a first filter; a code segment for subtracting said filtered noise signal from said tracking error signal to produce a resultant error signal, wherein filter coefficients of the first filter are selected by minimizing cross-correlation between the noise signal and the resultant error signal; and a code segment for removing a noise component from said noise signal prior to determining filter coefficients of the filter.

The present invention has the advantage over the prior art that it produces more accurate tracking error signals. According to embodiments the optical storage medium is an optical disc such as a CD, DVD or BD, including contour shapes differing from that of a circular disc, e.g. business card shapes; and the multiple-spots error signal is a three-spots push-pull tracking error signal.

These and other aspects, features and advantages of which the invention is capable of will be apparent and elucidated from the following description of embodiments of the present invention, reference being made to the accompanying drawings, in which

FIG. 1 is a diagram of an information layer on an optical disc;

FIG. 2 is a block diagram of a known three-spots push-pull tracking error signal detector;

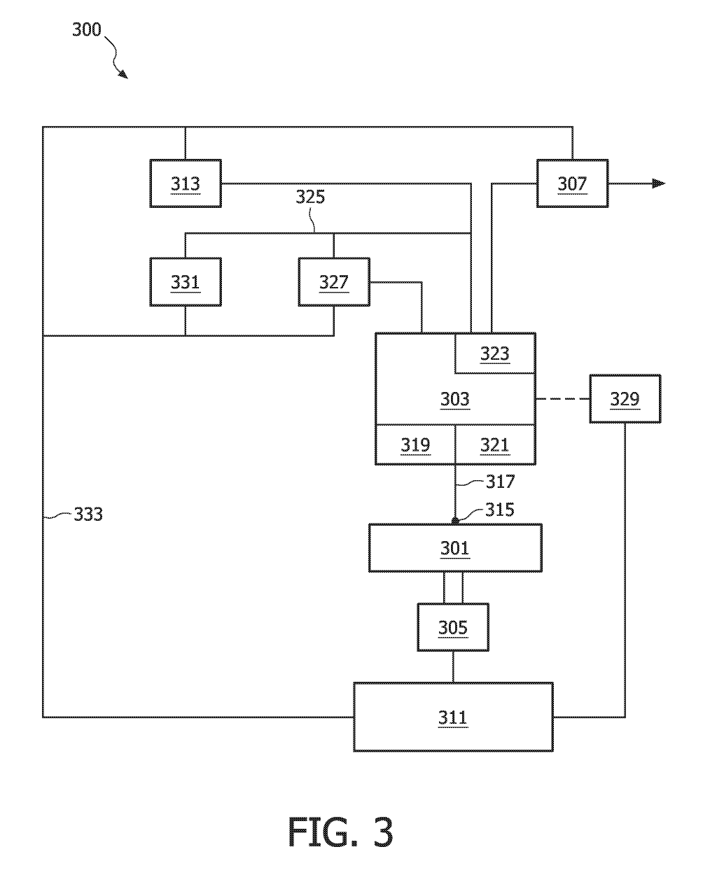

FIG. 3 is a block diagram of an optical system upon which the invention may be implemented;

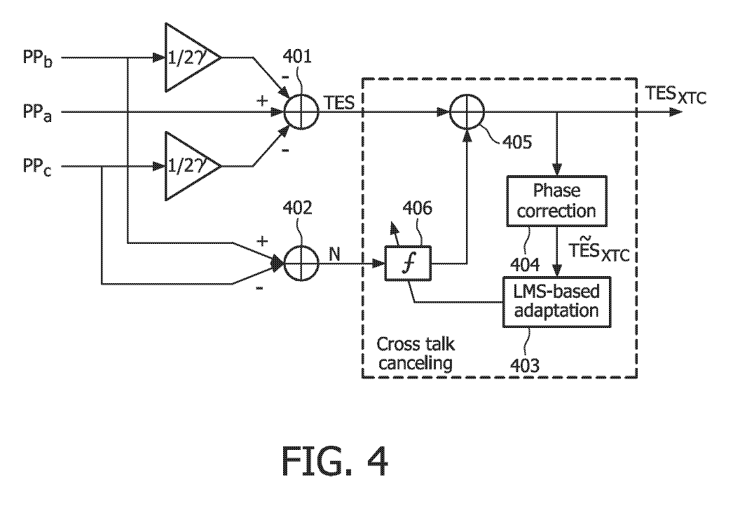

FIG. 4 is a block diagram of a cross-talk cancellation unit according to one embodiment of the invention;

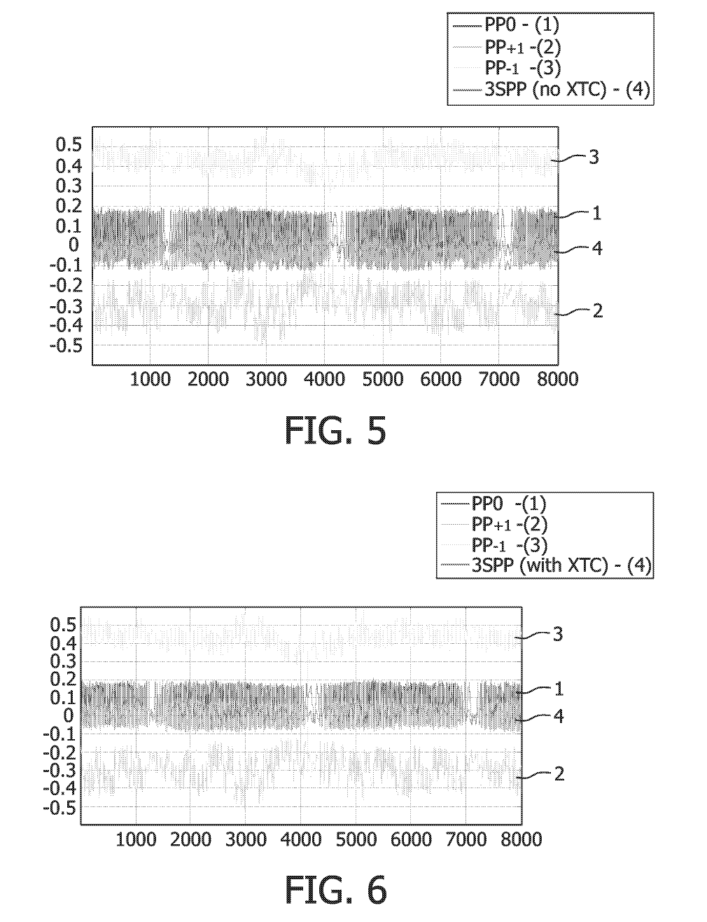

FIG. 5 illustrates signals before cross-talk cancellation;

FIG. 6 illustrates signals after cross-talk cancellation according to one embodiment of the invention;

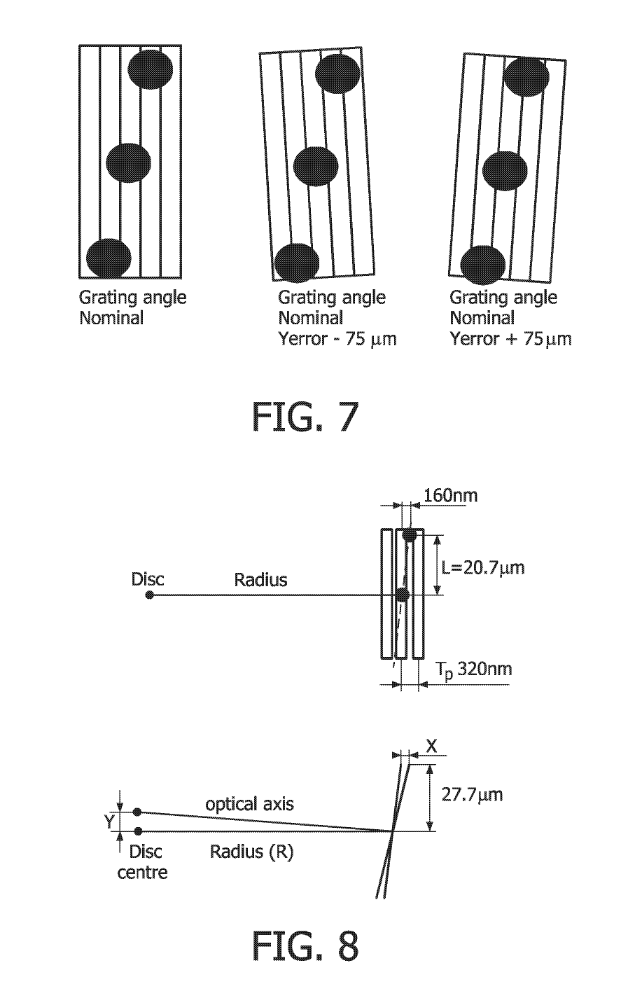

FIG. 7 illustrates spot positions on a disc in the case of radial run-out;

FIG. 8 illustrates radial run-out in a Blu-ray system;

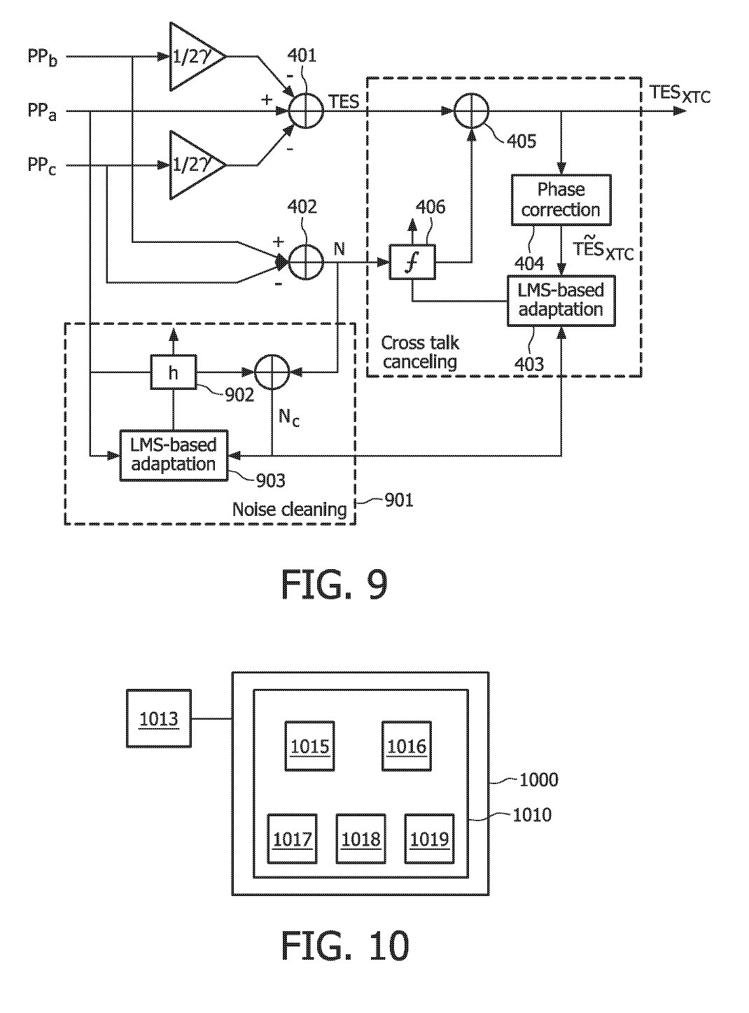

FIG. 9 is a block diagram of a cross-talk cancellation unit according to one embodiment of the invention; and

FIG. 10 is a computer readable medium according to one embodiment of the invention.

The following description focuses on an embodiment of the present invention applicable to cross-talk cancellation in a three-spot push-pull tracking error signal in an optical disc system. However, it will be appreciated that the invention is not limited to this application but may be applied to other systems.

FIG. 3 illustrates an optical reading/writing system upon which the invention may be implemented. The optical system 300 is arranged to read/write information to or from a disc 301. The system 300 is provided with a read head 303 for scanning the track on the disc 301 and read control means comprising drive means 305 for rotating the disc 301, a reading unit 307 for example comprising a channel decoder and an error corrector, tracking means 327 and a system control unit 311. The read head is also connected to a writing unit 313. The read head comprises an optical system of a known type for generating a radiation spot 315 focused on a track of the recording layer of the disc 301 via a radiation beam 317 guided through optical elements. The radiation beam 317 is generated by a radiation source, e.g. a laser diode. The reading head further comprises an actuator which comprises a focusing actuator coil 319 for focusing the radiation beam 317 on the disc 301 and a radial actuator coil 321 for fine positioning of the spot 315 in radial direction on the center of the track. A tilt actuator coil 323 may be used to change the angle of an element on a moveable part of the read head 303 or on a part on a fixed position in the case part of the optical system is mounted on a fixed position. The radiation reflected by the recording layer is detected by a detector of a usual type for generating detector signal 325 including a read signal, a tracking error and a focus error.

The apparatus 300 is provided with tracking means 327 coupled to the read head 303 for receiving the tracking error and controlling the radial and tilt actuators. During reading, the read signal is converted into output information in the reading unit 307. The apparatus 300 is provided with a header detector 331 for detecting the header areas of the tracks of the disc. The apparatus 300 has positioning means 329 for coarsely positioning the read head 303. Finally, the apparatus is further provided with the above mentioned system control unit 311 for receiving commands from a controlling computer system or from a user and controlling the operation of the apparatus 300 via a system bus 333.

According to one embodiment of the invention, cross-talk cancellation (XTC) is used. According to this embodiment, the noise component in the raw error signal TES is eliminated by subtracting a filtered version of a suitably defined noise signal N, where the filter coefficients are found by minimizing the cross-correlation between the noise signal N and the resultant error signal TES_{XTC}:

TES_{XTC}=TES−f(N), (7)

A suitable noise signal in the present case is the difference between the two satellite push-pull signals:

N=PP_{b}−PP_{c}=γN_{b}−γN_{c} (8)

This signal is inherently independent of the radial information (the term A sin φ), and of the beamlanding (the term B). In general N_{b}≠N_{c} because the spurious light spot(s) causing them experience different light paths, we have a non-zero signal N. It has a significant cross-correlation with the noise term in TES since they basically result from the same light sources, only that the light paths are different. An advantage of the cross talk cancellation (XTC) method is that it works irrespective of the root cause of the noise contributions. As such it can suppress noise induced tracking offsets that are due to a variety of physical causes with one and the same method.

FIG. 4 illustrates a block diagram of the cross-talk cancellation unit 400 according to one embodiment of the invention. The signals PPₐ, PP_{b}, PP_{c} are combined in the combination unit 401 to create TES. The noise signal N is created by determining the difference between PP_{b} and PP_{c} in the subtraction unit 402. A least-mean-square-error (LMS) algorithm is used to iteratively find the coefficients of the filter f. When the filter f is time varying due to, for example, that the noise channel characteristics are not constant within one disc revolution, the algorithm in the LMS-based adaption unit 403 is able to follow the variation of f by its adaptive nature. To enable the adaptation, a target function (or cost function) needs to be defined that, in this case, can be:

J(f)=(T\tilde{E}S_{XRC}×N)² (9)

the instantaneous form of the correlation between T\tilde{E}S_{XTC} and the noise signal N. T\tilde{E}S_{XTC} represents the phase-corrected version of TES_{XTC} that is filtered in the phase correction unit 404 by the sensitivity transfer function of the underlying tracking servo loop. This is to align the signal TES_{XTC} in phase with the noise signal N, which is necessary for the stability of the adaptation. According to the gradient descending rule, the update of the filter f (406) in the discrete domain becomes

$$f ( k + 1 ) = f ( x ) + μ x ( - \frac{\partial J}{\partial f} {\vert}_{k} ) \qquad ( 10 )$$

where μ is a positive constant controlling the update speed and the stability. The filtered noise signal is then combined with the TES in a combination unit 405 to create TES_{XTC}. The effect of XTC is demonstrated in FIGS. 5 and 6, where the signals used are sampled when the tracking loop is open. Noisy signals from a dual-layer Blu-ray Disc (BD) are plotted in FIG. 5. The signals are the three push-pull signals and the overall TES. Clearly, the two satellite push-pull signals have a noise contribution much larger than the actual error signal itself. Although the noise contributions of the two satellites are largely in anti-phase, a significant part feeds through in the three-spot push-pull signal. FIG. 6 illustrates the same signals and the three-spot push-pull signal after XTC. The improvement in the error signal quality can clearly be seen.

In this embodiment of the invention, the method may work properly only under the assumption that in the noise signal N there is not any component that has correlation with the track error signal A sin φ. The assumption is essential since otherwise the filter f used for XTC will get updated towards the direction that part of the useful tracking error signal A sin φ in TES is eliminated.

This assumption will be not satisfied any more when, for example, a radial run-out is present with which the two satellite spots become not exactly located halfway between the central track and adjacent tracks. The radial run-out results from the eccentricity of the disc. Its magnitude depends on the difference between the center point of the track circumference and the optical axis. Normally it is adjusted to minimum by tuning the disc eccentricity. In FIG. 7 and FIG. 8, examples of side spot positions with a radial run-out are shown, and also an illustrative drawing of radial run-out is given with Blu-ray disc parameters. In Blu-ray drives, a realistic value for radial run-out is around 75 μm, which corresponds to 59 nm shift of the satellite spot position at disc radius 26.5 mm and 29 nm shift at radius 53.0 mm, respectively.

Suppose the phase shift of the two satellite spot push-pull signals due to radial run-out is ε, and we have

PPₐ=A sin(φ)+B+Nₐ

PP_{b}=−A sin(φ−ε)+γB+γN_{b},

PP_{c}=−γA sin(φ+ε)+γB+γN_{c} (11)

Then the 3SPP tracking error signal TES and the noise signal N become

TES=A(1+cos ε)sin φ+Nₐ−(N_{b}+N_{c})/2

N=2γA sin ε cos φ+γ(N_{b}−N_{c}) (12)

Clearly, the noise signal N now depends on the radial position through the term 2γA sin ε cos φ. The filter f, therefore, will be improperly updated, leading to degradation of the XTC performance.

According to another embodiment of the invention, the above-described problem is solved. Before the noise signal N is used for the update of the filter coefficients, it needs to be pre-processed to remove the component 2γ A sin ε cos φ that gives undesired correlation with TES. This embodiment will now be described with reference to FIG. 9. FIG. 9 comprises the elements of FIG. 4 with the addition of a noise cleaning section 901. According to the present embodiment, the pre-processing of the noise can be realized as follows:

N_{C}=N−h*PPₐ, (13)

where h is an FIR filter 902. The coefficients of the filter h are found by minimizing the cross-correlation between PPₐ and the cleaned noise N_{C} in an LMS (Least Mean Square) based adaption unit 903. Since there is no beamlanding present in N and the tracking error signal A sin(φ) in PPₐ is much more dominant than Nₐ, the cross-correlation only comes from the existence of 2γ A sin ε cos φ in N. Hence, 2γ A sin ε cos φ will be eliminated from N when the cross-correlation is minimized.

Note, that after the pre-processing in (13) the beamlanding B may be introduced into N_{C} again, depending on the filter h. However, N_{C} will be only used for the learning of the filter f, or more accurately speaking, it only appears at the cross-correlation calculation with T\tilde{E}S_{XTC} where the beamlanding B has no impact, while in the actual cross talk cancellation in (7) N is still used. In this manner, the learning of the filter f may be improved, and in the meantime the beamlanding B is not re-introduced into the cleaned tracking error signal TES_{XTC}.

In another embodiment of the invention according to FIG. 10, a computer-readable medium is illustrated schematically. A computer-readable medium 1000 has embodied thereon a computer program 1010 for processing by a computer 1013, the computer program comprising code segments for increasing a dynamic voltage swing in an actuator system. The computer program comprises a code segment 1015 for determining a tracking error signal from a plurality of error signals; a code segment 1016 for determining a noise signal from at least two of the plurality of error signals; a code segment 1017 for filtering said noise signal in a first filter; a code segment 1018 for subtracting said filtered noise signal from said tracking error signal to produce a resultant error signal, wherein filter coefficients of the filter are selected by minimizing cross-correlation between the noise signal and the resultant error signal; a code segment 1019 for removing a noise component from said noise signal prior to determining.

The invention may be implemented in any suitable form including hardware, software, firmware or any combination of these. The invention may be implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described above with reference to a specific embodiments, it is not intended to be limited to the specific form set forth herein. Rather, the invention is limited only by the accompanying claims and, other embodiments than the specific above are equally possible within the scope of these appended claims, e.g. different systems than those described above, different numbers of satellite spots than two in addition to a central read/write spot.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. A method for cross-talk cancellation in a multiple-spots push-pull tracking error signal in an optical storage medium system, comprising:
determining a tracking error signal from a plurality of error signals;
determining a noise signal from at least two of the plurality of error signals;
filtering said noise signal in a first filter resulting in a filtered noise signal;
subtracting said filtered noise signal from said tracking error signal to produce a resultant error signal,
wherein filter coefficients of the first filter are selected by minimizing cross-correlation between the noise signal and the resultant error signal.

2. The method according to claim 1, comprising finding the coefficients of the filter by using a least-mean-square error algorithm therefor.

3. The method according to claim 2, comprising the phase correcting the resultant error signal prior to being applied to the least-mean-square error algorithm, so that the noise signal and the resultant error signal are in phase with each other.

4. The method according to claim 1, wherein the plurality of error signals are push-pull error signals.

5. The method according to claim 4, wherein a first error signal is from a main scanning spot and second and third error signals are from satellite scanning spots.

6. The method according to claim 5, wherein the noise signal is the difference between the second and third error signals.

7. The method according to claim 1, wherein an update of the filter in the discrete domain is
$$f ( k + 1 ) = f ( x ) + μ x ( - \frac{\partial J}{\partial f} {\vert}_{k} ) ,$$
where μ is a positive constant controlling update speed and stability.

8. The method according to claim 6, further comprising
removing a noise component from said noise signal prior to determining filter coefficients of the filter.

9. The method according to claim 8, comprising using a second filter to remove the noise component.

10. The method according to claim 9, comprising selecting filter coefficients for the second filter by minimizing cross-correlation between the first error signal and the filtered noise from the second filter.

11. A system for cross-talk cancellation in a multiple-spots push-pull tracking error signal in an optical disc system, comprising:
means (401) for determining a tracking error signal (TES) from a plurality of error signals (PPₐ, PP_{b}, PP_{c});
means (402) for determining a noise signal (N) from at least two of the plurality of error signals (PPₐ, PP_{b}, PP_{c});
a first filter (406) for filtering said noise signal (N) resulting in a filtered noise signal;
means (405) for subtracting said filtered noise signal from said tracking error signal (TES) to produce a resultant error signal (TES_{XTC}); and
wherein filter coefficients of the first filter (406) are selected by minimizing cross-correlation between the noise signal (N) and the resultant error signal (TES_{XTC}).

12. The system according to claim 11, further comprising a least-mean-square error algorithm unit (403) configured for iteratively finding the coefficient of the first filter (406).

13. The system according to claim 12, further comprising a phase correction unit (404) configured for correcting the phase of the resultant error signal prior to being applied to the least-mean-square error algorithm, so that the noise signal (N) and the resultant error signal (TES_{XTC}) are in phase with each other.

14. The system according to claim 11, further comprising means (901) configured for removing a noise component from said noise signal (N) prior to determining filter coefficients of the filter.

15. The system according to claim 14, wherein said means (901) configured for removing the noise component comprises:
a second filter (902) for filtering a first error signal (PPₐ);
a least mean square based adaption unit (903) for determining filter coefficients for the second filter (902), wherein the filter coefficients for the second filter (902) are selected by minimizing cross-correlation between the first error signal and the filtered noise from the second filter.

16. A computer-readable medium (1000) having embodied thereon a computer program (1010) for cross-talk cancellation in a three-spots push-pull tracking error signal in an optical disc system, for processing by a computer (1013), the computer program comprising:
a code segment (1015) for determining a tracking error signal from a plurality of error signals;
a code segment (1016) for determining a noise signal from at least two of the plurality of error signals;
a code segment (1017) for filtering said noise signal in a first filter resulting in a filtered noise signal;
a code segment (1018) for subtracting said filtered noise signal from said tracking error signal to produce a resultant error signal,
wherein filter coefficients of the filter are selected by minimizing cross-correlation between the noise signal and the resultant error signal.

17. The computer readable medium according to claim 16, further comprising:
a code segment (1019) for removing a noise component from said noise signal prior to determining filter coefficients of the filter.
